(19) United States
(12) Patent Application Publication
(10) Pub. No.: US 2003/0150115 A1
(43) Pub. Date: Aug. 14, 2003

(54) Precision press fit assembly using micro actuator

(76) Inventors: Michael David Kennedy, Boulder Creek, CA (US); Norbert Steven Parsoneault, Scotts Valley, CA (US)

Correspondence Address: MOSER, PATTERSON & SHERIDAN, LLP, Suite 250, 350 Cambridge Avenue, Palo Alto, CA, 94306, US

(21) Appl. No.: 10/165,680

(22) Filed: Jun. 7, 2002

Related U.S. Application Data
(60) Provisional application No. 60/356,426, filed on Feb. 11, 2002.

(51) Int. Cl. B21K 1/10; B21D 53/10; B21K 1/76; B23P 17/00

(52) U.S. Cl. 29/898.07

(57) ABSTRACT

To accurately locate a fluid dynamic bearing element along a shaft, the shaft is excited at or near its resonant frequency while applying a press force to the shaft, and holding the bearing element still. The assembly process then becomes a dynamic process, with the result that the positioning or locating of the shaft relative to the cone or other bearing element can be achieved with much greater accuracy.

A PZT (piezoelectric) element may be located between the press and the motor shaft with the frequency of the PZT element being a function chosen to effectively oscillate the shaft at or near its resonant frequency; thus the PZT element should be excited at the approximate axial resonant frequency of the shaft. The press structure which is used to apply the press force should have sufficient stiffness so as not to absorb the energy created by the PZT element, which would damp its effects.

### CROSS-REFERENCE TO RELATED APPLICATIONS

This invention is based on U.S. provisional application serial No. 60/356,426, filed Feb. 11, 2002, and entitled “Precision Press Fit Assembly Using Micro Actuator”, inventors Michael D. Kennedy and Norbert S. Parsoneault. The priority of this provisional application is hereby claimed in the application as incorporated herein by reference.

### FIELD OF THE INVENTION

The present invention relates generally to the field of fluid dynamic bearings, and more specifically to method and apparatus for assembling the elements of a fluid dynamic bearing on a shaft with a high degree of accuracy.

### BACKGROUND OF THE INVENTION

Disc drives are capable of storing large amounts of digital data in a relatively small area. The disc drives store information on one or more spinning recording media. The recording media conventionally takes the form of a circular storage disk in a plurality of concentric circular recording tracks. A typical disk drive has one or more disks for storing information. This information is written to and read from the disks using read/write heads mounted on actuator arms that are moved from track to track across surface of the disk by an actuator mechanism.

Generally, the disks are mounted on a spindle that is turned by a spindle motor to pass the surfaces of the disks under the read/write heads. The spindle motor generally includes a shaft supporting from a base plate and a hub to which the spindle is attached having a sleeve into which the shaft is inserted. Permanent magnets, which are typically attached to the hub, interact with a stator winding to rotate the hub relative to the shaft. This description is consistent with a fixed shaft motor; however, the invention to be described below is as easily useable with a motor comprising a rotating shaft, an end of the shaft supporting the hub for rotation to support the rotation of the disks.

In either case, to facilitate rotation, one or more bearings are disposed between the hub or sleeve and the shaft.

Over time, disk drive storage density has tended to increase, and the size of the storage system has tended to decrease. This trend has led to greater emphasis on restrictive tolerances in the manufacturing and operation of magnetic storage disk drives. For example, to achieve increased storage density, read/write heads must be placed increasingly close to the surface of the storage disk.

As a result, the bearing assembly which supports the storage disk is of critical importance. A typical bearing assembly of the prior art comprises ball bearings supported between a pair of bearing races which allow a hub of a storage disk to rotate relative to a fixed member. However, ball bearing assemblies have many mechanical problems such as wear, run-out and manufacturing difficulties. Moreover, resistance to operating shock and vibration is poor because of damping.

An alternative bearing design is a fluid dynamic bearing. In a fluid dynamic bearing, lubricating fluid such as air, gas or liquid provides a bearing surface between a fixed member of the housing (e.g., the shaft) and a rotating member which supports the disk hub. Hydrodynamic bearings spread the bearing interface over a large surface area in comparison with a ball bearing assembly, which comprises a series of point interfaces. This is desirable because the increased bearing surface reduces wobble and run-out between the rotating and fixed members. Further, the use of fluid in the interface area imparts damping effects to the bearing which helps to reduce non-repeat run-out.

However, it is apparent from a study of the art and technology of fluid dynamic bearings that accurately establishing the gap between the two relatively rotating surfaces is an important feature of the operability of the invention. Typical bearing gap run on the order of 2-15 microns; obviously, a method and/or apparatus for setting gaps to this level of precision, while carried out within reasonable cost and time constraints, is a demanding request. Current assembly processes used for motor assemblies utilize, in one instance, a static press for setting the axial location of a cone on a shaft. The cone location is set by increasing the force on the shaft until the static friction between the two components is exceeded. Since the compressed length of the shaft acts as a spring, once the static friction is broken, the stored energy in the shaft can cause a jump of stick/slip phenomenon that limits the axial resolution capability of the pressing process.

### SUMMARY OF THE INVENTION

The present invention is intended to provide a method and apparatus for accurately establishing the axial location of an element of a fluid dynamic bearing on a shaft. More particularly, the present invention is intended to provide method and apparatus for accurately setting the axial location of a cone on a shaft.

The present invention is further intended to overcome some of the limitations of the prior art in accurately locating a cone or the like on a shaft within the desired limits of axial resolution. In summary, a typical approach has been to brace or otherwise support a cone or other fluid dynamic bearing element which is to be located along a shaft, while applying a press force to the shaft. Pursuant to the present invention, the shaft is excited at or near its resonant frequency while applying the press force. The assembly process then becomes a dynamic process, with the result that the positioning or locating of the shaft relative to the cone or other bearing element can be achieved with much greater accuracy. As a result of reducing the energy stored in the shaft which normally occurs with a pure static force application, the jumping or stick-slip phenomenon described in the prior art is or eliminated, providing for sub micron movement resolution of the axial location of the cone or other element on the shaft.

In a preferred implementation of the process, a PZT (piezoelectric) element is located between the press and the motor shaft with the resonant frequency of the PZT element being chosen with a resonant frequency matching or substantially near to the axial resonant frequency of the shaft. A surrounding press structure which is used to apply the press force should have sufficient stiffness so as not to absorb the energy created by the PZT element, which would damp its effects.

Other features and advantages of this invention may become apparent to a person of skill in the art who studies the following disclosure of a preferred embodiment given with respect to the following drawings.

### BRIEF DESCRIPTION OF THE DRAWINGS

FIG. 1 is a perspective view of a disk drive in which the shaft and bearing element assembled according to the present invention is useful;

FIG. 2 is a vertical sectional view of a known bearing system as used in the prior art which may be more easily and accurately assembled using the present invention;

FIG. 3 is a schematic diagram of an embodiment of the present invention; and

FIG. 4 is a sectional view of a second embodiment of the present invention.

### DETAILED DESCRIPTION OF PREFERRED EMBODIMENTS OF THE INVENTION

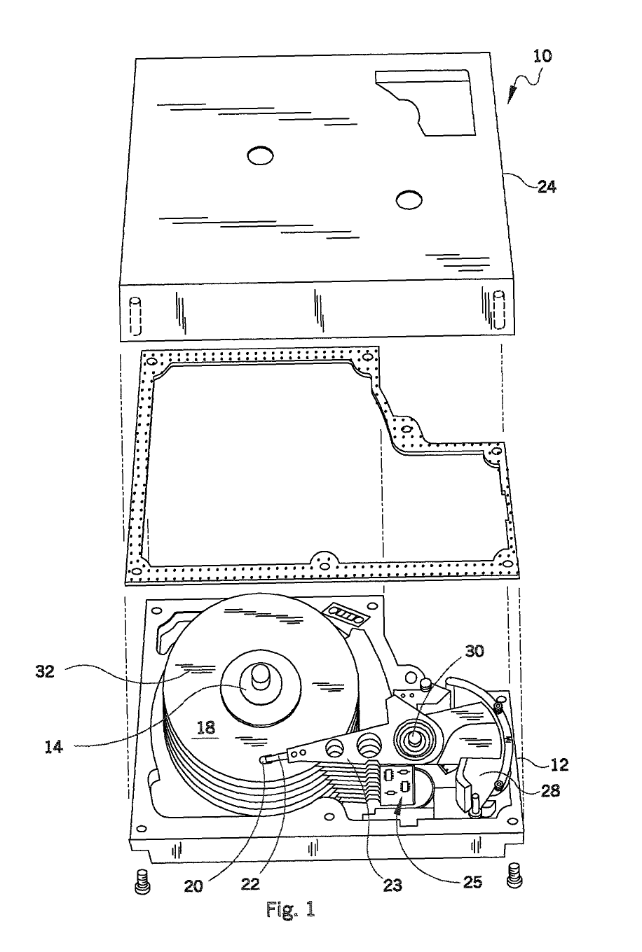

FIG. 1 depicts a plan view of an embodiment of a typical disc drive in which embodiments of the present invention, because of its stability and long life are especially useful. Referring to FIG. 1, the disc drive 10 includes a housing base 12 and a top cover 24. The housing base 12 is combined with cover 24 to form a sealed environment to protect the internal components from contamination by elements outside the sealed environment. The base and top cover arrangement shown in FIG. 1 are well known in the industry. However, other arrangements of the housing components have been frequently used and there is no particular limitation to the configuration of the housing.

The disc drive further includes a disc pack comprising one or more discs mounted for rotation on a spindle motor not shown by disc clamp 14. The disc pack 16 of one or more discs provides discs mounted for rotation about a central axis. Each disc surface has an associated read/write head 20 which is mounted to disc drive 10 for communicating with the disc surface. In the example shown in FIG. 1, read/write heads 20 are supported by flexures 22 which are in turn attached to head mounting arms 23 of an actuator body 25. The actuator shown in FIG. 1 is of the type known as a rotary moving coil actuator and includes a voice coil motor shown generally at 28. The voice coil motor rotates the actuator body 25 with its attached read/write heads 20 about a pivot shaft 30 to position read/write heads 20 over a desired data track along a path 32. While the rotary actuator is shown in FIG. 1, the invention may be used with other disc drives having other type of actuators such as linear actuators; in fact, the specific disc drive shown herein is intended only to be exemplary, not to be limiting in any sense.

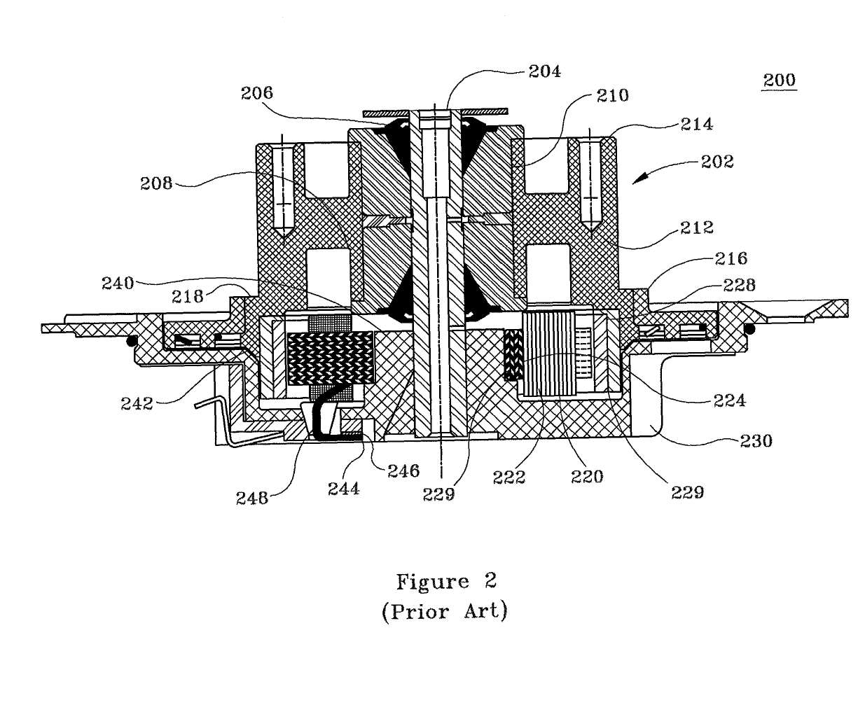

FIG. 2 is a vertical sectional view of a known spindle motor including a set of conical hydrodynamic bearings 206, 208 which [support] enable the shaft 204 and hub 202 for relative rotation. The motor is a brushless direct current motor 200 comprising a hub 202 rotatably mounted about the stationary shaft 204 by the upper and lower bearings 206 and 208 respectively. The hub 202 which supports one or more discs such are as shown in FIG. 1 for rotation is formed in a generally inverted U shape as seen in cross section, and has an inner annulus sleeve 210 and an outer cylindrical surface 212 and a top portion 214. Outer cylindrical surface 212 includes a shoulder 216 for supporting one or more discs in the contaminant free environment which encloses the motor and discs. A plurality of storage discs separated by spacers or washers could easily well be stacked along the vertical length of outer cylindrical surface 212. The inner portion of hub 202 operably receives a stator, generally designed 220, including a stator lamination stack 224 and stator windings 222. A permanent magnet 228 is mounted on a back iron 229 supported from outer annular arm 212 for magnetically interacting with magnetic reactor stator laminations stack 224 and stator windings 222. It is to be understood that a plurality of permanent magnets may make up the magnet 228 in this design.

The disc drive motor 200 is assembled by installing the rotor assembly comprising the shaft, bearings and hub into the frame/stator assembly to make up a motor assembly mounted to a frame or base member 230 of disc drive assembly 10 (FIG. 1) by inserting it in the recess in member 230.

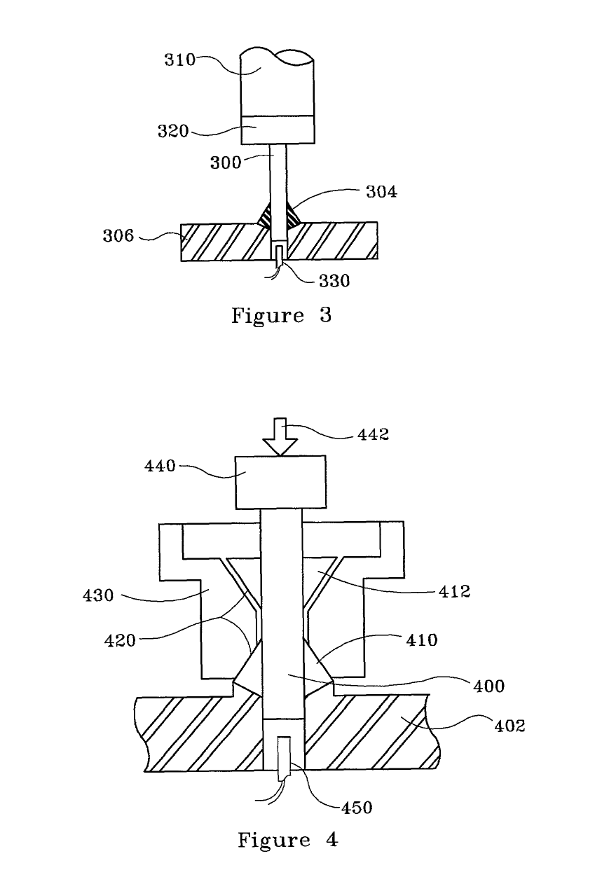

Turning next to FIG. 3, a simple embodiment of the apparatus of the present invention which can be used implement the method appears. Shown in this figure is a shaft 300 on which a fluid bearing element comprising cone 304 of a type which would typically be mounted on a shaft to form a conical fluid dynamic bearing. To carry out the process according to the prior art, the cone would have been supported in a base 306, and pressed at a constant force using a static press or the like 310.

To implement the method of the present invention, a PZT element 320 which can apply a high frequency oscillatory motion to the shaft is imposed between the press 310 and the shaft 300. Before this step is carried out, typically the cone 304 would be roughly positioned on the shaft, and the difference between the actual position of the cone on the shaft and the target position measured. Thereafter, the press 310 with the PZT element 320 can be pressed against the shaft, the press applying a constant force; and the PZT element is activated to excite the shaft preferably at or near its resonant frequency while applying the press force. This step of the method is carried out until the cone 304 is positioned at the desired location on the shaft 300. The positioning can be determined either periodically by stopping the excitation of the shaft to measure the position or the amount of movement of the cone relative to the shaft using a probe 330 such as is known in this technology; or constant monitoring for movement of the shaft can be utilized. In either case, once the shaft has been moved the desired distance relative to the cone 304 so that the desired position has been achieved, then the excitation of the shaft with the PZT element as well as the imposition of static force 310 is ended. In contrast to the prior art, as a result of the reduction or elimination of energy stored in the shaft 300 while the press force is being applied, the jumping or stick/slip phenomenon is eliminated, giving way to sub micron resolution.

The desired resonant frequency of the PZT element in carrying out this step is a function typically of an element or a shaft thickness in the direction of excitation. Therefore, the PZT selection should be done based on the shaft design for a given product. It is further desirable that the surrounding press structure should have sufficient stiffness so as not to absorb the energy created by the PZT element, which would tend to damp its effects.

A working example is shown in FIG. 4. In this figure, which shows a method and apparatus for locating two cones on a shaft, with the PZT element being used to achieve the proper spacing between the cones, the motor shown in FIG. 2 is now upside down for final positioning of the cones. The cone 410 rests in a base 402. The cones 410, 412 for the conical bearing have been roughly positioned along the shaft 400 and their relative positioning or gap spacing 420 has been established so that the deviation between the target spacing and the actual spacing 420 is known. Also, of course, the hub 430 is in place as it would not be possible to put it in place after installing of the cones. Next the PZT element 440 which is preferably in place against the end of the pressing source 442 is placed against the end of the shaft.

As a preliminary to this step, the resonant frequency of the shaft has been determined by doing a normal modes analysis. The axial resonant frequency of the shaft is primarily a function of the shaft length, Young's modules and the shaft's material density. For example, in one experiment the shaft 400 was determined to have a resonant frequency of 62.3 kHz; then a 1.14 inch (28.96 mm) PZT element 440 was selected as having a resonant frequency of approximately 60 kHz. Therefore, this combination would provide excitation of the shaft 400 at its longitudinal resonant frequency.

The PZT element 440 is then excited, while the pressing source 442 is applied, the shaft 400 will of course slip slowly relative to the cone 410 because of the cone 410 being held in the fixture or base 402. A probe 450 is provided to either constantly or intermittently measure the movement and positioning of the shaft so that when the desired amount of movement of the shaft relative to the cone 400 has been achieved, the process is stopped. The shaft has now been accurately positioned relative to the cones, and the desired spacing 420 of the cones has been achieved.

Alternative embodiments of this invention could of course be adopted. For example, the positioning of a thrust plate or the like relative to a shaft could be achieved in the same way simply by causing the thrust plate to rest in the base and vibrating the shaft until the desired positioning is achieved.

Other features and advantages of the invention as well as other alternatives may be adopted. Therefore, the scope of the present invention is to be limited only by the following claims.

1. A method of accurately positioning an element of a fluid dynamic bearing on a shaft comprising roughly positioning said element on the shaft,
supporting the element in a fixture,
applying a press force axially along the shaft to move the shaft relative to the element, and
exciting the shaft at a high frequency in the axial direction, the shaft thereby being accurately positioned relative to the fluid dynamic bearing element.

2. A method as claimed in claim 1, wherein the fluid dynamic bearing element is a cone.

3. A method as claimed in claim 2, wherein the shaft is excited at about its resonant frequency.

4. A method as claimed in claim 2 including the steps after pressing the cone roughly into a first preset position on the shaft, measuring the difference between the preset position and a target position for the cone on the shaft to establish a desired distance the cone must be moved along the shaft, and exciting the shaft while applying the press force until the cone has been moved the desired distance along the shaft.

5. A method as claimed in claim 4 wherein the shaft is excited axially at approximately the resonant frequency of the shaft.

6. A method as claimed in claim 5 wherein the shaft is axially excited while the axial press force is applied.

7. A method of assembling a motor comprising a shaft, a sleeve and hub rotatable around the shaft, relative rotation of the sleeve and hub being supported by a pair of fluid dynamic bearings spaced along the shaft, each of the bearings comprising an element supported on the shaft and spaced across a defined gap from a surface on the sleeve, wherein the method comprises positioning a first one of the elements along the shaft, positioning the sleeve on the shaft, positioning the second element along the shaft and applying a press force against the shaft to move the shaft relative to the supported elements, and exciting the shaft at a frequency while applying the press force, whereby the elements are moved to a desired spacing between the first and second elements.

8. A method as claimed in claim 7, wherein each of the first and second elements is a conical element.

9. A method as claimed as claimed in claim 8, wherein the shaft is excited at about its resonant frequency while applying the press force.

10. A method as claimed in claim 7 including the steps after pressing the cone roughly into a first preset position on the shaft, measuring the difference between the preset position and a target position for the cone on the shaft to establish a desired distance the cone must be moved along the shaft, and exciting the shaft while applying the press force until the cone has been moved the desired distance along the shaft.

11. A method as claimed in claim 10 wherein the shaft is excited axially at approximately the resonant frequency of the shaft

12. Apparatus for assembling a fluid dynamic bearing comprising a pair of fluid dynamic bearing elements supported along a shaft and spaced apart by a defined distance to establish a desired gap between each of the fluid dynamic bearing elements and a sleeve which cooperates with the bearing elements to define a fluid dynamic bearing design, the apparatus comprising frame means for supporting one of the elements on the shaft, and means for applying a force axially along the shaft, and means for exciting the shaft while applying the force to locate the elements a defined distance apart along the shaft.

13. Apparatus as claimed in claim 12 wherein the means for exciting the shaft excites the shaft at or near a resonant frequency of the shaft.

14. Apparatus as claimed in claim 13 wherein the means for exciting the shaft comprises a piezoelectric transducer (PZT).

15. Apparatus as claimed in claim 12 wherein the piezoelectric transducer is axially aligned with the source of static, the means for providing static force axially along the shaft.

16. A method as claimed in claim 11 wherein the method includes constantly monitoring the movement of the shaft while the shaft is excited to determine when the shaft moves the desired axial distance.
